(19) United States
(12) Patent Application Publication
(10) Pub. No.: US 2003/0198505 A1
(43) Pub. Date: Oct. 23, 2003

(54) Filing system for holding personal information and method therefor

(76) Inventor: Karen D. Stoesz, Scottsdale, AZ (US)

Correspondence Address: WEISS & MOY PC, 4204 NORTH BROWN AVENUE, SCOTTSDALE, AZ, 85251, US

(21) Appl. No.: 10/123,760

(22) Filed: Apr. 19, 2002

(51) Int. Cl. B42F 3/00

(52) U.S. Cl. 402/70

(57) ABSTRACT

A system for organizing and storing information in a plurality of different categories has a plurality of binders wherein each binder is used to hold and store information for a particular category. A plurality of envelopes are removably stored within each binder. Each envelope is used to hold a sub-category of information related to the particular category of the binder which the envelope is removably stored.

### BACKGROUND OF THE INVENTION

1. Field of the Invention

This invention relates to a filing system, and more specifically, to a filing system which allows one to divide personal information and effects into a plurality of different category books wherein each of the book holds and stores the information in an orderly manner.

2. Description of the Prior Art

In order to utilize time more wisely, many individuals like to organize information and data in small related groups. For example, many individuals will keep a list of “things to do”, important dates, financial information, health information, insurance information, etc. Presently, many individuals use personal organizers and Personal Digital Assistants (PDAs) to store information. However, the information stored in personal organizers and PDAs generally need to be typed or handwritten into the organizer. Personal organizers and PDAs do not allow documents and other sheet-like elements to be held and stored.

Most individuals like to place documents and sheet-like elements into a file drawer or folder for storage. However, after placing several documents into a file or folder, the file/folder tends to become cluttered and unorganized. Furthermore, if too many documents are placed in a file/folder, documents tend to fall out and become lost.

Therefore, a need existed to provide an improved storage and organization system and method therefor. The improved storage and organization system and method will be used for storing and holding personal information and data in an organized manner.

### SUMMARY OF THE INVENTION

In accordance with one embodiment of the present invention, it is an object of the present invention to provide an improved storage and organization system and method.

It is another object of the present invention to provide an improved storage and organization system and method that will be used for storing and holding personal information and data in an organized manner.

### BRIEF DESCRIPTION OF THE EMBODIMENTS

In accordance with one embodiment of the present invention a system for organizing and storing information in a plurality of different categories is disclosed. The system comprises a plurality of binders wherein each binder is used to hold and store information for a particular category. A plurality of envelopes are removably stored within each binder. Each envelope is used to hold a sub-category of information related to the particular category of the binder which the envelope is removably stored.

In accordance with another embodiment of the present invention a method for organizing and storing information in a plurality of different categories is disclosed. The method comprises the steps of: providing a plurality of individual binders wherein each binder is used to hold and store information for a particular category; selecting the binders for which category of information a user wants to organize and store information; and providing a plurality of envelopes within each binder wherein each envelope is used to hold and store information in a sub-category related to the particular category of the binder which the envelope is removably stored.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings.

FIG. 1 is a perspective view of a single subject organizer used in the present invention.

FIG. 2 is an interior view of the single subject organizer depicted in FIG. 1.

FIG. 3 is a front view of an envelope used in the single subject organizer depicted in FIG. 1.

### DETAILED DESCRIPTION OF THE PREFERRED EMBODIMENT

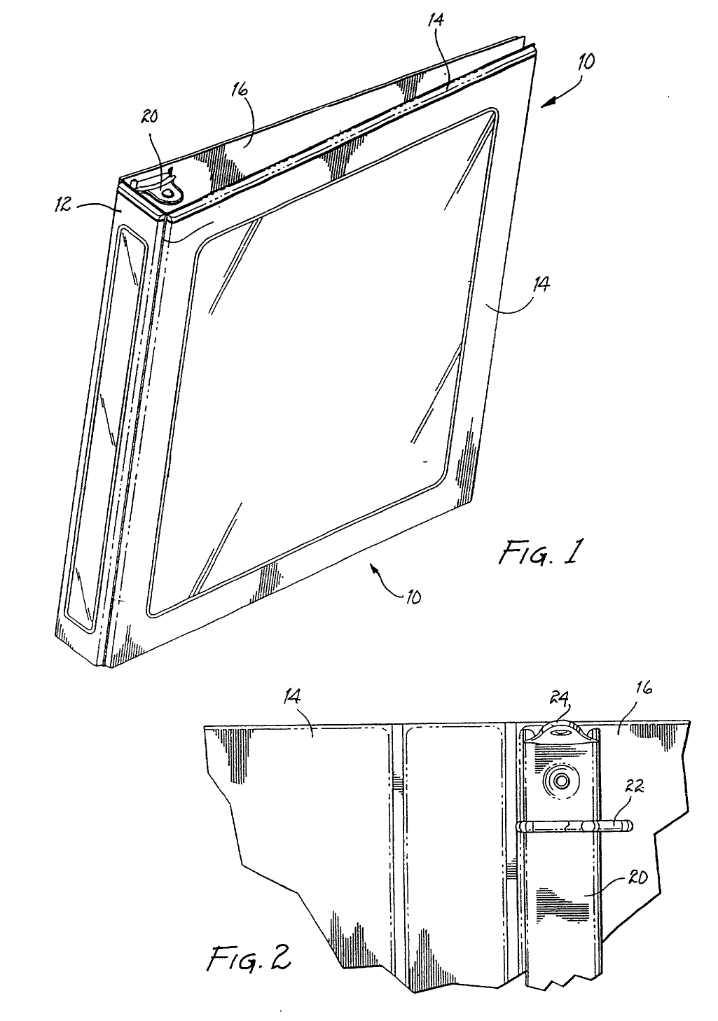

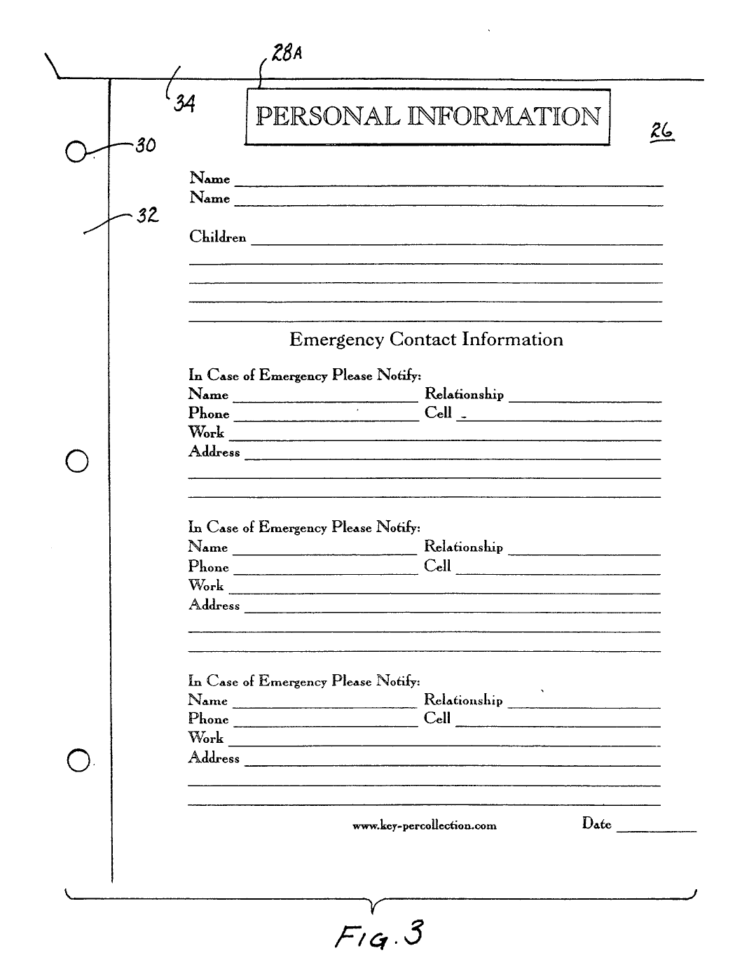

The present invention is a personal information storage and organizer system (hereinafter system). Referring to FIGS. 1 and 2, the system is comprised of a plurality of different binders 10. Each binder 10 will be designated to hold and store information for a specific category. Referring now to Appendix A, an index of the system is shown. As may be seen, the system 10 may have one or more binders 10 for each of the listed categories. It should be noted that the listing is just given as an example and should not be seen as to limit the scope of the present invention. Other categories may be used without departing from the spirit and scope of the invention. Furthermore, there does not have to be a binder for each category.

Each binder 10 will have a spine 12. Coupled to the spine 12 will be a front cover 14 and a back cover 16. Also coupled to the spine 12 will be a ring assembly 20. The ring assembly 20 sill have a plurality of rings 22 and a mechanism 24 for opening and closing the rings 22. In general, three rings 22 will be used. However, this should not be seen as to limit the scope of the present invention. The rings 22 are used to hold a plurality of different holders 22. The holders 22 are used for storing information. The holders 22 may be folders, envelopes, and the like. In the embodiment which will be described, the holder 22 will be an envelope 22. However, this should not be seen as to limit the scope of the present invention.

As may be seen from FIG. 3, each envelope 26 will have a front side 28. The front side 28 will have a title section 28A which will list the general information for which the envelope 26 will be used to store information. Below the title section 28A will be areas in which information may be written. Each envelope 26 will hold and store a subgroup of information which is related to the general category of the binder 10 in which the envelope 26 is placed. This can be seen more clearly by looking at Appendix A.

The envelope 26 will have a plurality of holes 30. In general, the number of holes 30 are equal to the number of rings 22. The holes 30 are aligned so that the rings 22 may hold the envelope 22 within the binder 10. The holes 30 are reinforced so that the holes 30 will not tear thus allowing the envelope 26 to fall out of the binder 10. In general some type of tape 32 may be used to reinforce the holes 22. The envelope 26 will have an opening 34 located on the envelope 26. In the embodiment depicted in FIG. 3, the opening 34 is located on a top section of the envelope 26. However, this should not be seen as to limit the scope of the present invention. The opening 34 may be located on the side of the envelope 26 or elsewhere. The opening 34 will allow information such as documents, other sheet-like elements, booklets, cards, etc. to be held and stored within the envelope 26. It should be noted that the listing of the different types of information should not be seen as to limit the scope of the present invention. Other types of information may be held and stored within the envelope 26. The opening 34 will have a cover which may be closed to ensure that information will not come out of the opening 34.

When using the system, a user will select a predetermined number of binders 10. The user will select those binders 10 in which the user would like to organize certain information. For example, the user may want to organize his/her financial information, health information and medical information. Thus, the user will have three separate binders 10 for these three different categories. Each binder 10 will have a plurality of different envelopes 26 corresponding to the sub-categories shown in Appendix A. It should be noted that not all the sub-categories need to have an envelope 26. Furthermore, additional envelopes 26 for sub-categories not shown may also be included. The user will fill-in the information on the front of the envelopes 26 he/she intends to use. The user will then place documents and other sheet-like elements within the envelope 26 through the opening 34 and close the opening so that the documents will not fall out.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A system for organizing and storing information in a plurality of different categories comprising, in combination:
a plurality of binders wherein each binder is used to hold and store information for a particular category; and
a plurality of envelopes removably stored within each binder wherein each envelope is used to hold a sub-category of information related to the particular category of the binder which the envelope is removably stored.

2. A system for organizing and storing information in a plurality of different categories in accordance with claim 1 wherein each binder comprises:
a spine;
a front cover coupled to the spine;
a rear cover coupled to the spine; and
an assembly coupled to the spine for holding the plurality of envelopes.

3. A system for organizing and storing information in a plurality of different categories in accordance with claim 2 wherein the assembly comprises:
a plurality of rings for holding the plurality of envelopes; and
a mechanism coupled to the plurality of rings for opening and closing the plurality of rings.

4. A system for organizing and storing information in a plurality of different categories in accordance with claim 1 wherein each envelope comprises:
an envelope which is approximately the length and width of the binder;
a plurality of holes located along one side of the envelope to allow the assembly to hold the envelope within the an opening located on the top of the envelope which allows documents to be placed within the envelope; and
a cover coupled to the opening for closing the opening.

5. A system for organizing and storing information in a plurality of different categories in accordance with claim 4 wherein the envelope further comprises enforcement material coupled to the plurality of holes to protect the holes from tearing.

6. A system for organizing and storing information in a plurality of different categories in accordance with claim 5 wherein the enforcement material is a MYLAR tape.

7. A system for organizing and storing information in a plurality of different categories comprising, in combination:
a plurality of binders wherein each binder is used to hold and store information for a particular category, each binder comprising:
a spine;
a front cover coupled to the spine;
a rear cover coupled to the spine; and
an assembly coupled to the spine for holding a plurality of envelopes, wherein the assembly comprises:
a plurality of rings for holding the plurality of envelopes; and
a mechanism coupled to the plurality of rings for opening and closing the plurality of rings; and
a plurality of envelopes removably stored within each binder wherein each envelope is used to hold a sub-category of information related to the particular category of the binder which the envelope is removably stored, wherein each envelope comprises :
an envelope which is approximately the length and width of the binder;
a plurality of holes located along one side of the envelope to allow the assembly to hold the envelope within the
an opening located on the top of the envelope which allow s documents to be placed within the envelope; and
a cover coupled to the opening for closing the opening.

8. A system for organizing and storing information in a plurality of different categories in accordance with claim 7 wherein the envelope further comprises enforcement material coupled to the plurality of holes to protect the holes from tearing.

9. A system for organizing and storing information in a plurality of different categories in accordance with claim 8 wherein the enforcement material is a MYLAR tape.

10. A method for organizing and storing information in a plurality of different categories comprising the steps of:
providing a plurality of individual binders wherein each binder is used to hold and store information for a particular selecting the binders for which category of information a user wants to organize and store information; and
providing a plurality of envelopes within each binder wherein each envelope is used to hold and store information in a sub-category related to the particular category of the binder which the envelope is removably stored.

11. The method of claim 10 wherein the step of providing a plurality of individual binders further comprises the steps of:
providing a spine;
providing a front cover coupled to the spine;
providing a rear cover coupled to the spine; and
providing an assembly coupled to the spine for holding the plurality of envelopes.

12. The method of claim 1 1 wherein the step of providing an assembly further comprises the steps of:
providing a plurality of rings for holding the plurality of envelopes; and
providing a mechanism coupled to the plurality of rings for opening and closing the plurality of rings.

13. The method of claim 10 wherein the step of providing a plurality of envelopes comprises the steps of:
providing an envelope which is approximately the length and width of the binder;
providing a plurality of holes located along one side of the envelope to allow the assembly to hold the envelope within the providing an opening located on the top of the envelope which allows documents to be placed within the envelope; and
providing a cover coupled to the opening for closing the

14. The method of claim 13 wherein the step of providing a plurality of envelopes further comprises the step of providing enforcement material coupled to the plurality of holes to protect the plurality of holes from tearing.
